(19) United States
(12) Patent Application Publication
(10) Pub. No.: US 2011/0194476 A1
(43) Pub. Date: Aug. 11, 2011

(54) SELECTIVE COMMUNICATIONS NETWORK FUNCTIONALITY

(75) Inventors: Jason Gerard, Cavan, SA (AU); Ashleigh Glen Quick, New South Wales (AU)

(73) Assignee: CLIPSAL AUSTRALIA PTY LTD, South Australia (AU)

(21) Appl. No.: 12/526,292

(22) PCT Filed: Feb. 6, 2008
(86) PCT No.: PCT/AU08/00150

§ 371 Date: Mar. 23, 2011

(30) Foreign Application Priority Data
Feb. 9, 2007 (AU) 2007900639

(51) Int. Cl. H04W 88/02; H04W 4/06

(52) U.S. Cl. 370/312; 455/7; 455/19

(57) ABSTRACT

Disclosed are a method, system and apparatus for use in a network of devices which can facilitate the installation of the network. In a network consisting of multiple devices, it is often necessary to use repeaters to relay communications between two or more devices that are out of range of each other. The various aspects of the present invention provide for one or more of the devices to be selectively switched to operate as a repeater.

### TECHNICAL FIELD

The present invention relates to a network of devices which communicate with each other via radio frequency.

### INCORPORATION BY REFERENCE

The following publications are referred to in the present application:
PCT Patent Application No. PCT/AU2004/001052 (WO2005/015774) entitled “Radio Network Communication System and Protocol Using An Automatic Repeater”
PCT Patent Application No. PCT/AU2004/001053 (WO2005/015811) entitled “Radio Network Communication System and Protocol”
PCT Patent Application No. PCT/AU2004/001054 (WO2005/015751) entitled “Collision Detection in a Non-Dominant Bit Radio Network Communication System”
Australian Provisional Patent Application No. 2007900637 entitled “Wireless Network Communications System”
Australian Provisional Patent Application No. 2007900639 entitled “Selective Communications Network Functionality”.
   the entire contents of each of which is hereby incorporated by reference.

### BACKGROUND

Short range wireless communication networks are becoming more widely used and in more and more applications, including commercial and domestic applications. Such networks can consist of from two to many nodes, between which wireless communications occur. In one particular application, such nodes or devices can be used as part of a building infrastructure for control and monitoring purposes. This is commonly referred to as Home or Building Automation.

Two factors relevant to such networks are:
1. Reliability—Obtaining reliable radio communication between the nodes presents a considerable challenge, because when radio is used in buildings it suffers from interference and attenuation. There are many sources of interference and attenuation, including the type of building materials used, other wireless devices, and the objects placed inside the building.
2. Scalability—Most networks have an upper limit on the number of nodes that can exist in a network. This limit can in some cases be difficult to determine, and can have many causes, including exceeding radio range (the distance between nodes becoming too great), or more frequently, consuming all of the available radio bandwidth. This latter case is also known as congestion.

There are many wireless communication systems presently deployed, which aim to solve these problems. Most available systems solve one problem only, at the expense of making the other problem worse.

Some systems currently deployed use explicit routing of messages between nodes. In such systems, each node needs to know the path to every possible destination, through a series of intermediate nodes. This improves reliability, but has some consequent disadvantages:
a. Messages may be repeated by many intermediate nodes, leading to a long “on-air” time for a given piece of information as it is in transit from its source to its destination.
b. Each node needs to know the path to every possible destination, which means that each node needs to have the memory to store that path, and a means of placing the path into the device.
c. Such a system does not scale very well, because when one transmitting device wishes to communicate with several receiving devices, it must have routing for each of those destinations. Due to the physical limits on memory, the size of these tables is limited.
d. Scalability is also limited by wireless congestion due to the need to repeat multiple messages over a large number of devices or nodes, this being dependent on the number of nodes in the network.

Other systems use a technique known as “mesh” networking. In this technique, some or all of the devices that receive a message will retransmit it, so that the message propagates to all edges of the network. Mesh networking provides better reliability because messages can be repeated many times. Mesh networking systems further fall into two broad categories. The first whereby all nodes can repeat and some central controller coordinates their operation. The second whereby repeating and non-repeating nodes are separate and distinctly different (either by hardware, or software, or both) to each other.

However, existing mesh networks suffer from certain disadvantages such as:
because messages are repeated by many nodes, adding more repeating nodes to a network can quickly cause congestion (because messages are being repeated so often, even if the repeating is not needed);
this approach also makes poor use of bandwidth by having messages repeated many times, even if the repeat is not needed. A consequence is either increased latency, or the need for higher bandwidth than would otherwise be needed;
some of these mesh networking systems require a specific node to be designated as a central controller to coordinate the operation of the network; and
some of these mesh networking systems require a separate repeater node to be designed and then placed at an appropriate physical location to perform the repeating function.

Thus existing mesh networks are not always the best type of network for a particular application.

Networks used in building automation systems require that devices be installed into a building on a permanent or semi-permanent basis. Such installation normally requires incorporation of the devices into the building structure—for example by making holes in walls. In some cases, replacement of existing equipment with new wireless equipment means that the existing building structure cannot be modified. Thus, shifting a device for better wireless operation or replacing a device with a more suitable device for its location is often not feasible.

Similarly, the effects of the physical environment on the wireless operation are often unknown until the wireless devices have been installed.

It is an object of the present invention to provide a method and system which facilitates the setup of a wireless network system in a building or structure.

### SUMMARY OF THE INVENTION

According to a first aspect of the present invention, there is provided a device for use in a network of devices, the device able to be selectively switched to a repeating device.

In one form, the device comprises:
An antenna for receiving and transmitting data;
A transceiver for receiving and transmitting the data to or from the antenna;
A microprocessor for processing the data in accordance with a communications protocol in a non-repeat mode and in a repeat mode; and
An input device for causing the microprocessor to switch between the non-repeat mode and the repeat mode.

In one form, the device further comprises a mode indicator for indicating the mode of operation of the device.

According to a second aspect of the present invention, there is provided a network comprising at least one device according to the first aspect of the present invention.

In one form, the network is a multicast acknowledged communications network.

According to a third aspect of the present invention, there is provided a method of installing a network of a plurality of devices, at least one of which is according to the first aspect, the method comprising:
installing the plurality of devices; and
causing at least one of the plurality of devices to adopt a repeater mode.

According to a fourth aspect of the present invention, there is provided a method of installing a network of a plurality of devices, at least one of which is according to any one of claims 1 to 3, the method comprising:
causing at least one of the plurality of devices to adopt a repeater mode; and
installing the plurality of devices.

In one form, the step of causing the at least one of the plurality of devices to adopt the repeater mode comprises actuating a switch on the device.

In another form, the step of causing the at least one of the plurality of devices to adopt the repeater mode comprises remotely actuating a switch.

### DRAWINGS

The invention will now be described with reference to the following drawings in which:

FIG. 1—shows one possible application of one aspect of the present invention in a room;

FIG. 2—shows a representation of a network with 3 devices that use multi-cast communication, with node C transmitting and nodes A and B receiving;

FIG. 3—shows a larger network in which not all nodes are in range of each other.

FIG. 4—shows an even larger network in which nodes form various clusters;

FIG. 5—shows a Transmission frame according to an exemplary protocol used prior to a node adopting repeat functionality;

FIG. 6—shows the network of FIG. 4 after three nodes adopt repeat functionality;

FIG. 7—shows an exemplary architecture of a network device according to an aspect of the present invention; and

FIG. 8—shows a more detailed example of the microprocessor/switch interaction of the device of FIG. 7.

### DETAILED DESCRIPTION

Various aspects of the present invention will now be discussed in more detail, in the context of a building control or home automation system. It will be understood however, the various aspects of the present invention are equally applicable to other wireless network applications, including but not limited to extending the range of wireless headsets, wireless computer peripherals (such as keyboard, mouse, printer, scanner).

FIG. 1 shows an exemplary application of an aspect of the present invention as applied to a domestic home automation system. Of course, the example could equally illustrate a commercial office set up or other application.

In FIG. 1, there is shown a network 10 of devices arranged in a room 1 having a window 2, the devices performing various functions. In particular, there is shown in this example, a television 3, audio system 4 with associated speakers 4a and 4b, air conditioning system 5, curtain control system 6 with associated curtain 6a, lights 7a, 7b, 7c and 7d, wall controller 8 and remote controller 9.

Each of devices 3 to 7 are devices that may be controlled by controller devices 8 and/or 9. In one aspect, remote controller 9 may also control wall controller 8 to then control each of devices 3 to 7, as well as optionally directly controlling each of devices 3 to 7. For example, curtain 6a could be drawn and opened via the user operating wall controller 8 directly, or by the person using remote controller 9 directly, or by controlling wall controller 8 via remote controller 9.

Similarly, lights 7a to 7d could be turned on or off or otherwise dimmed at wall controller 8, or the user could control the room illumination directly via remote controller 9, or the user could control the illumination by controlling wall controller 8 via remote controller 9.

It will be understood that these devices and this arrangement is exemplary only, and any other set up could be used, including multiple rooms, multiple buildings and any other controllable device such as coffee machines, security alarm or monitoring systems, hot water appliances and ovens, as well as office equipment including printers, facsimile machines and telephone conference devices.

It will also be understood that wall controller 8 is exemplary only, and could take other forms, including portable, battery powered, mains (line) powered, built into the building structure, or freestanding. In addition wall controller 8 could form part of a network with many other similar controllers.

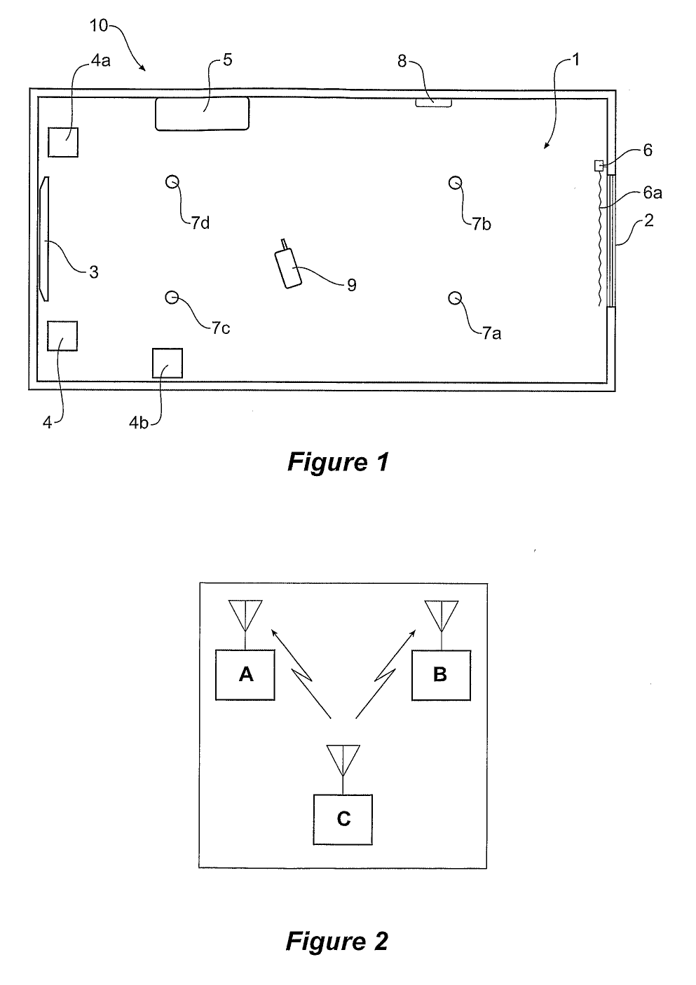

FIG. 2 shows a simple wireless network 10 having three devices, each forming one of three nodes A, B and C of the network, and which wirelessly communicate with each other. In one example, the network 10 is a lighting control network and node A may be a light, node B may be a sensor (for example for detecting the presence or movement of a person) and node C may be a controller such as a light actuator or a light dimmer.

The devices may also be a combination sensor/actuator, or some other control or interface point which connects to a larger and more sophisticated computerised building management system. In another example, node A may be a stereo system, node B may be a stereo controller and node C may be a sensor. In yet another example, network 10 could be an environmental control system and node A could be an air conditioning and/or heating device, node B could be a sensor and node C could be a controller.

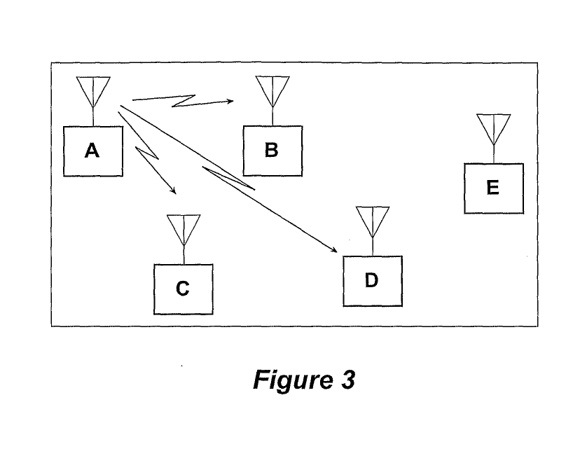

FIG. 3 shows a more complex installation in which not all nodes are in range of each other. In this case, nodes A and E cannot communicate with each other because they are too far apart. Nodes B and D however are in a position to be able to communicate with all nodes. Nodes B or D are good candidates therefore for operating as a repeater to facilitate communication between nodes A and E for example.

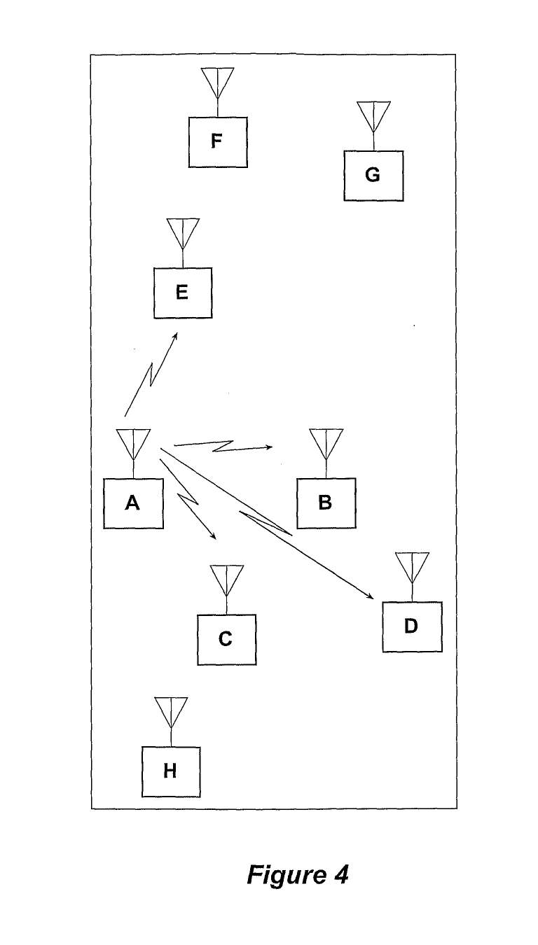

FIG. 4 shows a more extreme example again, where nodes A, B, C, D form a cluster—all are in range of each other.

Nodes E, F, G also form a cluster, and are all in range of each other.

Nodes A, B, E form another cluster—all being in range of each other.

Nodes C & H form another cluster again.

These clusters can be seen by overlaying imaginary circles representing the RF range, and looking at the regions of overlap. In this case, nodes F and G are outside the range of nodes A, B, C, D & H.

For complete end-to-end communication, nodes A, C & E all need to be designated as repeaters.

In the case where the devices in the systems of FIG. 3 or FIG. 4 are to be controlled, a common characteristic is that the locations of the devices (for example, a light, a wall controller, a stereo system) have either fixed physical locations, or locations where the occupiers prefer them to be placed. In the event that some devices cannot communicate with other devices, for example because of a lack of RF range, the ability is needed to quickly and easily designate any device as a repeater.

Because no two buildings, rooms, building contents, or owners are alike, it is often impossible to determine in advance where a repeater node should be located.

By installing the wireless networking systems and components, it will rapidly become apparent to an installer where performance problems exist—because some devices simply won't communicate, as illustrated in FIGS. 3 and 4 above. In that case, the installer may find a device located at a place in between the regions which will not communicate, and, according to one aspect of the present invention, immediately designate that device as a repeater by a simple operation which does not require the device to be removed, modified, shifted, or otherwise altered.

According to one aspect of the present invention, one or more devices within the network 10 may be selected to operate as a repeater network device. This may be done if it is determined after, or during installation, that the network would operate better as a mesh or repeater network rather than as a non-mesh or non-repeater network.

A number of methods exist which will enable an installer or even an end-user to determine the efficiency of an installed network. Such methods include testing the performance of the devices within the network, taking measurements of RF signal strength at various points about and within the network, or a simple walk-around may be all that is needed to show that communication from—for example, the back of a house to the front of the house, is either not present at all, or not reliable. In such a case, an approximately centrally-located repeater device will solve the problem.

By allowing a device installed in that vicinity to be quickly and easily designated as a repeater, the performance of the network is improved, without requiring the installation of extra devices, reprogramming central controllers, or performing other complex, expensive or time-consuming operations. It will also be appreciated that in the case where one or more nodes have been physically encased in a building for example, the ability to re-assign the repeating function to an encased node without having to remove it from its location is useful.

Upon determination that one or more devices or nodes should operate as a repeater, the installer or other person may selectively switch one or more, or all of the devices to operate as a repeater, to thereby turn network 10 into a partial or complete mesh or repeater network.

For example, in the case of the network illustrated in FIG. 4, if the installer determines that the network will perform more efficiently with devices or nodes A, C and E acting as repeaters, the installer can turn those devices into repeaters. This may be done by a number of means, including operating a switch, positioning an electric or other jumper, or being interactively guided through a selecting or de-selecting software process.

Of course it will also be understood that an installer can often estimate, prior to beginning or completing installation of the network, that a particular device or node will need to be a repeater. In this case, the installer can selectively switch the device to repeater mode and install the device as appropriate. This provides great flexibility in installing the network, as well as providing greater flexibility in the installer purchasing and storing devices in his or her own business for logistical purposes.

A specific example will now be given for a network using the protocols described in detail in PCT/AU2004/001052, and PCT/AU2004/001053, and in the network arrangement as shown in FIG. 4 of the present application for devices or nodes A, B, C, D, E, F, G and H. In the first instance, all devices or nodes are non-repeating devices.

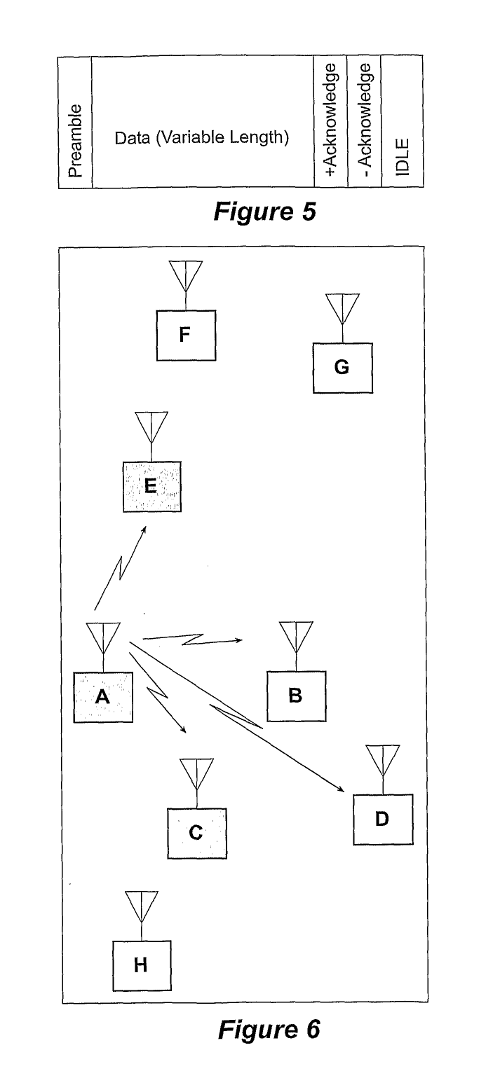

In the present example, the protocol used by the network is as follows. In this example, a Transaction is specifically defined as a continuous period of time broken up into several sub-time slots containing different types of data. A Transaction will begin with a preamble for a set period of time, followed by the specific data which is to be transmitted from a transceiver/transmitter to two or more transceiver/receivers. The timeslot during which the data is transmitted is variable in length, and includes a portion used as a frame check sequence. Following the data transmission is a timeslot during which positive acknowledgement can be transmitted by the transceiver/receivers, followed by a timeslot during which negative acknowledgement is transmitted by the transceiver/receivers. The structure of this frame is shown in FIG. 5.

A Transaction is asynchronous and can start at any time. However, once started, the Transaction has a time-based structure. Special markers in the Transaction are used to show the beginning and end of the variable length data portion. The time slots during which the positive and negative acknowledgement are transmitted, are fixed in time. By coding and redundancy of data encoded into these timeslots, a positive acknowledgement by one or more transceiver/receivers and a negative acknowledgement by one or more transceiver/receivers can be conveyed. All of the devices involved in the Transaction see both of the acknowledgement timeslots.

Transceiver/receivers wishing to positively acknowledge, will transmit a special code during the positive acknowledge timeslot and during the negative acknowledge timeslot will either receive (if dominant bit transmission is not used) or transmit inferior bits (if dominant/inferior bits are used).

Similarly, transceiver/receivers wishing to negatively acknowledge will either transmit inferior bits (if dominant/inferior bits are used) or receive (if dominant bit transmission is not used) during the positive acknowledge timeslot and transmit a special code during the negative acknowledge timeslot.

Upon installation, it may be determined from simple routine tests as described above, that transmissions from device A are only received by devices B, C, D and E. Devices F, G and H do not receive transmissions from device A as they are out of range.

As previously described, it is a simple matter to deduce that for full communications between all devices or nodes, devices A, C and E should be designated as repeater devices.

Rather than have to rearrange the devices, which may not suit the intended application, or replace non-repeater devices A, C and E with repeater devices, which in some cases may be difficult, such as when one or more of devices A, C and E have been installed inside a wall or other non-easily accessible area, devices A, C and E may be easily designated as repeater devices. For example, the installer or other person may selectively switch each of devices A, C and E to repeater mode by any suitable means including physically pushing a switch on the device itself, passing a magnetic field over the device to cause the switching (thus not requiring direct contact if the device is installed within the building for example), or even by a remote signal (for example infra red or microwave) received by an appropriate receiver on the device, which switches the device from non-repeater mode to repeater mode.

It is even conceivable that the network itself can automatically select and switch devices within itself in various ways until it is determined that all devices are able to communicate with each other, without the intervention of a person.

The network shown in FIG. 4 now appears as shown in FIG. 6, with devices A, C and E shaded to indicate that they are now acting as repeaters.

As could be seen in the network of FIG. 4, devices and A and F for example were unable to communicate, as they were out of range. Now, as shown in FIG. 6, device E is now a repeater, able to relay communications between device A and device F. Thus, if device A transmits data, repeater device E will receive this transmission from device A and retransmit the data such that device F will receive device A's data. Devices A and E use the arrangement with positive and negative acknowledgements to ensure that the message is passed between devices at each step of the way. Device E acts in a store-and-forward manner to pass the information along.

Of course, device F for example need not be a transceiver/receiver but may be a transceiver/transmitter. In this case, device F will transmit information to the network however, because device A (for example a transceiver/receiver) being out of range of device F would not receive the transmitted data. Again, repeater device E, being disposed between device A and device F, will receive the data transmitted by device F, and retransmit this data so that device A and any other devices within the range of repeater device E will receive the retransmission. The process of ensuring a valid transmission, based on acknowledgement, is similar to that described above, with device E acknowledging the transmission from device F, and other devices in range similarly acknowledging the repeated transmission by device A.

The above has been described using a particular protocol as described in PCT/AU2004/001052 and PCT/AU2004/001053, however, it will be understood that the various aspects of the present invention may be used in relation to any suitable protocol able to accommodate a selectable repeating functionality.

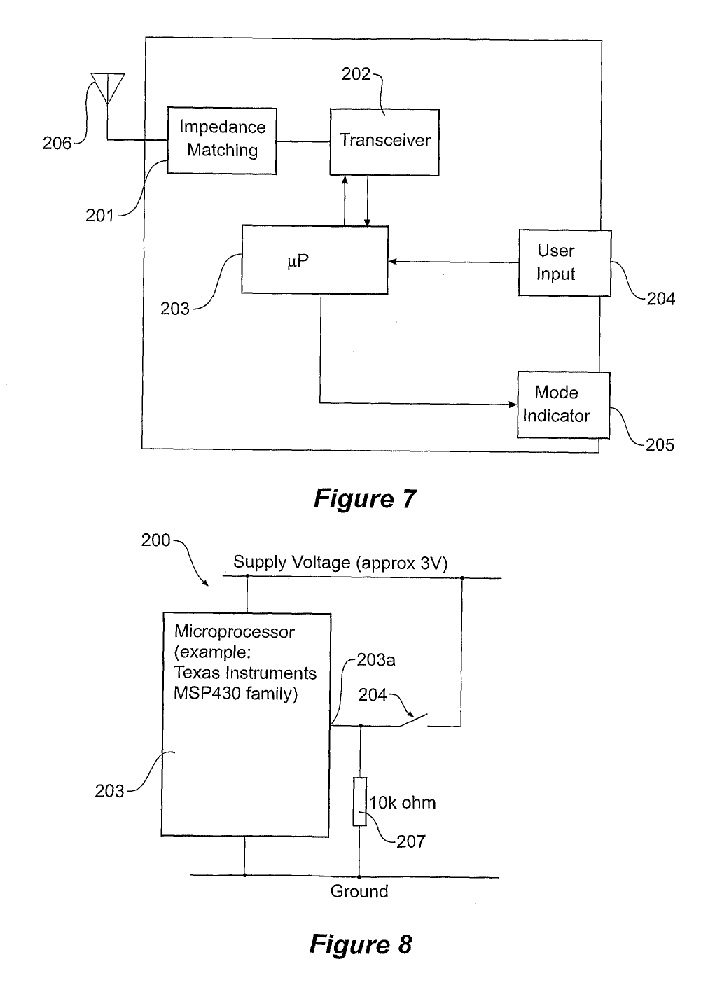

FIG. 7 shows an exemplary architecture of a device 200 (for example device A in FIGS. 4 and 6) according to one aspect of the present invention. In particular, there is shown an antenna 206 connected to a transceiver 202, via an optional impedance matching circuit 201. The transceiver 202 is in turn connected to a microprocessor 203 for passing received and transmitted data information to software running in the microprocessor 203. A user input device 204 is used to feed a user selection to the software running in the microprocessor 203. Optionally, the user can be shown the current mode (i.e. repeater function active/not active) using some form of indicator device 205.

In a typical implementation, the antenna 206 will be custom designed to suit the device. The impedance matching circuit 201, if present, will be designed to suit the antenna 206 and transceiver 202. The transceiver 202 could be either a discrete circuit, or an off-the-shelf transceiver IC. Such integrated circuits are available from many manufacturers including, but not limited to, Texas Instruments, Motorola, Chipcon, Nordic, RF Monolithics, and many others. Some transceivers include automatic impedance matching, and such a transceiver would remove the need to include impedance matching circuit 201.

The microprocessor 203 will be chosen to provide a suitable capacity to operate the communication protocol, the repeating function, and any other functions desired of the device 200. Typical microprocessors are available from many manufacturers, including Atmel, Texas Instruments, Zilog, Freescale, ST, and many others.

The user input device 204 may be a switch, a jumper, a push button, a touch screen, or any other device by which a user can turn the repeating function on and off. The optional indicator device 205 may be a lamp, a light emitting diode, a sound, wording or symbols on a screen, or any other means of showing a user the state of the repeating function.

In the case where the user input device 204 is a push button, software running on the microprocessor 203 may operate a simple state machine—for example whereby a first press turns the repeating function on, a second press turns it off, a third press turns it on again, and so on. Numerous variations on this are possible.

FIG. 8 shows a more specific example of the switch/microprocessor interaction of the device of FIG. 7. FIG. 8 shows microprocessor 203 (in this example, a microprocessor from the MSP430 family produced by Texas Instruments may be used) with a switch 204 (the specific implementation of the user input in this example) connected to an input pin 203a of the microprocessor 203. Input voltage may be applied to the input pin 203a as provided by resistor 207. The value of resistor 207 in this example is 10 k, but will be selected as appropriate according to supply voltage and the specifications of the microprocessor used, as will be apparent to the skilled addressee.

If the switch 204 is single-pole, single-throw type, then software running in the microprocessor 203 monitors the state of the input pin 203a, which will be either a binary 0 or binary 1 depending on the state of the attached switch 204. By selection of an appropriate convention (open/closed/binary 1/binary 0) the switch being open can, for example, select the non-repeating mode, and the switch being closed can, for example, select the repeating mode.

If on the other hand the switch 204 of FIG. 8 is a momentary contact type, it can be used to toggle between the repeating and non-repeating modes. Again, software running in the microprocessor 203 monitors the switch through the state of the associated input pin—but in this case the software swaps states each time the switch 204 becomes open or closed, using an algorithm as shown below:

```
IF switch changes from open to closed THEN
    IF mode is non-repeating THEN
        set mode to repeating
    ELSE
        set mode to non-repeating
    END IF
END IF
```

The switch input 203a to the microprocessor 203 may be de-bounced using any of a number of well-known techniques. It will also be appreciated that component values and power voltages shown are typical to suit the chosen microprocessor and application, and may vary considerably from one component manufacturer to another. Again, selection of appropriate values is well known to those skilled in the art.

When the selective repeater function is used in conjunction with the communication protocols described in any one or more of PCT/AU2004/001052, PCT/AU2004/001053 and PCT/AU2004/001054, a small microprocessor with approximately 20K to 60K of program memory, and 1K to 2K of operating variable (RAM) memory is suitable.

The operating frequency of the device 200 will be determined by local regulations, and choice of transceiver 202. For low power operation, frequencies in most parts of the world include 433.92 MHz, 868 MHz, 916 MHz and a band located at approximately 2400 MHz.

It will be appreciated that a network of devices may be constructed by a plurality of devices in which all of the devices are able to be switched from non-repeating mode to repeating mode, or in which only one of the devices is so enabled, or in which any number from one to all are so enabled. For example in a particular network configuration, it may be suspected that one particular node may need to be a repeater and so the device placed at that location may be switched to enable its repeating function if it is deemed necessary after the installation is complete.

In another aspect, the invention also provides for a machine readable medium containing software with instructions for causing a machine or device to perform the steps of any one or more of the methods or functions described herein. Such software may be downloaded onto a microprocessor for example, of a device that has a user input functionality, to allow it to function as a repeater or not, depending upon the input from the user input.

Specific embodiments of the invention have been described in detail with reference to and as illustrated in the accompanying figures. These embodiments are illustrative, and not meant to be restrictive of the scope of the invention. Suggestions and descriptions of other embodiments may be included within the scope of the invention but they may not be illustrated in the accompanying figures or alternatively features of the invention may be shown in the figures but not described in the specification.

Throughout this specification and the claims that follow unless the context requires otherwise, the words “comprise” and “include” and variations such as “comprising” and “including” will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

It will be understood that the above has been described with reference to a particular embodiment and that many variations and modifications may be made as will be understood by the person skilled in the art.

1. A device for use in a network of devices, the device able to be selectively switched by a person, between a non-repeater mode and a repeater mode.

2. A device according to claim 1 wherein the device comprises:
an antenna for receiving and transmitting data;
a transceiver for receiving and transmitting the data to or from the antenna;
a microprocessor for processing the data in accordance with a communications protocol in a non-repeater mode and in a repeater mode; and
an input device for causing the microprocessor to switch between the non-repeater mode and the repeater mode.

3. A device as claimed in claim 2 further comprising a mode indicator for indicating the mode of operation of the device.

4. A network comprising at least one device according to claim 1.

5. A network as claimed in claim 4 wherein the network is a multicast acknowledged communications network.

6. A method of installing a network of a plurality of devices, at least one of which is according to claim 1, the method comprising:
installing the plurality of devices;
determining whether the at least one of the plurality of the devices should be a repeater device, and if so;
causing at least one of the plurality of devices to adopt a repeater mode.

7. A method of installing a network of a plurality of devices, at least one of which is according to claim 1, the method comprising:
determining whether the at least one of the plurality of the devices should be a repeater device, and if so;
causing at least one of the plurality of devices to adopt a repeater mode; and
installing the plurality of devices.

8. A method as claimed in claim 6 wherein the step of causing the at least one of the plurality of devices to adopt the repeater mode comprises actuating a switch on the device.

9. A method as claimed in claim 6 wherein the step of causing the at least one of the plurality of devices to adopt the repeater mode comprises remotely actuating a switch.
